(19) United States
(12) Patent Application Publication
(10) Pub. No.: US 2003/0236975 A1
(43) Pub. Date: Dec. 25, 2003

(54) System and method for improved electronic security credentials

(75) Inventors: Peter Daniel Birk, Austin, TX (US); David Yu Chang, Austin, TX (US); Derek Wan Hok Ho, Austin, TX (US)

Correspondence Address: Joseph T. Van Leeuwen, P.O. Box 81641, Austin, TX, 78708-1641, US

(73) Assignee: International Business Machines Corporation, Armonk, NY (US)

(21) Appl. No.: 10/177,432

(22) Filed: Jun. 20, 2002

(51) Int. Cl. H04L 9/00

(52) U.S. Cl. 713/156; 713/201

(57) ABSTRACT

A system and method for improved electronic security credentials is presented. A client sends a request to a server wherein the request includes a user's identity information. The server authenticates the user using the user's identity information, and creates an authentication credential. The server stores the user's identity information in the authentication credential in the same form as it was received. If the server determines that the request should be sent to a downstream server, the server creates a message and includes the user's identity information in the message. The continued propagation of the user's original identity information preserves the integrity of the user's identity on a server-by-server basis. Each server may map this information to a credential in a way that it chooses based upon the server's underlying authentication mechanism and mapping rules.

### BACKGROUND OF THE INVENTION

1. Technical Field

The present invention relates in general to a system and method for improved electronic security credentials. More particularly, the present invention relates to a system and method for improving security credentials to allow more interoperability between security mechanisms.

2. Description of the Related Art

Businesses are increasingly dependent upon computer systems to support business activities. A computer system compromise either in terms of information loss, information inaccuracy, or competitor access to information may be costly to a business. Security breaches compromise computer systems and are becoming more frequent and varied. Security breaches may often be due to accidental misuse of the computer system, such as a user accidentally gaining unauthorized access to information. However, computer systems may also be subject to malicious attacks to gain access to sensitive information.

Distributed computer systems are more vulnerable to security breaches than more traditional computer systems since distributed computer systems include more places where the computer system may be attacked. A security system typically focuses on four main areas to protect computer systems from unauthorized access attempts. These four areas are confidentiality, integrity, accountability, and availability. Confidentiality ensures that information is disclosed only to authorized users. Integrity ensures that only authorized users are able to modify information using authorized ways. Accountability ensures that users are accountable for their security-relevant actions, such as non-repudiation. Availability ensures that users may not be maliciously denied access.

The Object Management Group (OMG) is an organization that establishes industry guidelines and object management specifications to provide a common framework for application development. OMG has developed specifications that particularly focus on network security. One such specification is the Common Security Interoperability version 2 (CSIv2) document which defines various levels of security architectures between computer systems. A developer follows CSIv2 security architecture definitions in order to ensure interoperability with other computer systems.

The CSIv2 document includes a definition for a security protocol called Security Attribute Service (SAS). The Security Attribute Service (SAS) protocol is designed to exchange protocol elements that are communicated over a connection-based transport. The SAS protocol is intended to be used in environments where transport layer security is used to provide message protection (i.e. integrity and/or confidentiality) and server-to-client authentication. The SAS protocol provides client authentication, delegation, and privilege functionality that may be applied to overcome corresponding deficiencies in an underlying transport. For example, the SSL/TLS protocol does not enforce client authentication and, in a given environment, certificate-based client authentication may not be feasible since clients often do not have a certificate. The SAS protocol facilitates interoperability by serving as the higher-level protocol under which secure transports may be unified.

In a computer system, message requests are often passed downstream from one server to another server. Many security verification mechanisms exist that a server may use to authenticate or authorize a user, such as LTPA (Lightweight Third Party Authentication), Kerberos, and LocalOS. A challenge found with passing messages downstream from one server to another server is that each server must have the same security mechanism in order to pass a particular authentication principal to a receiving server. Or, the sending server must send a user id/password combination to the receiving server so the receiving server can perform its own user authentication.

Another challenge found is that the OMG CSIv2 specification does not effectively specify a relationship between the SAS protocol and the Security programming model. Particularly, the CSIv2 specification describes how the Target Security Service (TSS) interprets information within the security context received in the message. However, the CSIv2 specification does not define the way in which this information is converted to credentials nor what is stored in the credentials. Much of how the credentials are formed is mechanism specific.

It is important to support existing OMG security service API's without the impact of the CSIv2 protocol. The semantics of application programs should be maintained regardless of the chosen security protocol. What is needed, therefore, is way to create credentials objects to represent authentication principles while supporting existing OMG security service API's.

### SUMMARY

It has been discovered that adding an identity token attribute to a security context message and adding an identity assertion credential at a server allows a computer system to use different methods of security verification while still supporting existing OMG security service API's. The identity token includes a requestor's identity assertion (IA) value and an identity assertion (IA) type. The IA value identifies the requestor, such as a user id, and the IA type corresponds to the identity type included in the IA value. A downstream server stores the IA value and IA type in the same form as it receives them. This is useful in preserving the identity of the original requestor if the downstream server forwards the IA value and IA type to a second downstream server.

A user sends a request to a client. The client retrieves authentication information from the user, creates a basic credential, and stores the user's authentication information in an identity attribute located in the basic credential. For example, the user's authentication information may be a user id and a password. The client creates a first security context message which includes the user's authentication information and sends the first security context to a first downstream server. The first downstream server receives the security context message and proceeds to authenticate the user. The first downstream server may use a security service for authentication purposes if applicable, such as if the user's authentication information includes a user id and password.

When the user is authenticated, the first downstream server receives an authentication token corresponding to the user from the security service. The first downstream server creates an authentication credential which includes the user's authentication token and an identity assertion (IA) attribute. The IA attribute, or IA token, includes an IA value which may be a user id, a principal, a distinguished name, or a certificate chain from an SSL mutual authentication connection. The IA token also includes an IA type identifier which identifies the type of identification stored in IA value. The first downstream server stores the IA value and IA type in the same form as they were received. By storing the IA value and IA type in the same form as they were received, the user's integrity is preserved if the first downstream server forwards the IA token to a second downstream server.

The first downstream server determines that the user's request should be sent to a second downstream server. The first downstream server creates a second security context message which includes the IA token and an authentication token corresponding to the identity of the first downstream server. The second downstream server receives the second security context message and authenticates the first downstream server using the authentication token included in the second security context message.

Once the first downstream server is authenticated, the second downstream server retrieves the IA value and the IA type identifier from the identity token. The second downstream server creates an IA credential and stores the user's IA value and the IA type identifier in the IA credential. The second downstream server stores the IA value and IA type in the same form as they were received in order to preserve the user's integrity. The second downstream server uses information in the IA credential to send a security context message to a third downstream server if required.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a server sending a security context message to a downstream server based upon a client request;

FIG. 2 is a high-level flowchart showing steps taken in an upstream server sending a security context to a downstream server;

FIG. 3 is a flowchart showing steps taken in authenticating a client;

FIG. 4 is a flowchart showing steps taken in generating an authentication credential using client information;

FIG. 5 is a flowchart showing steps taken in building a security context using an authentication credential and a server's identity;

FIG. 6 is a flowchart showing steps taken in a downstream server processing a security context message which is sent from an upstream server;

FIG. 7 is a flowchart showing steps taken in creating an identity assertion (IA) credential; and

FIG. 8 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

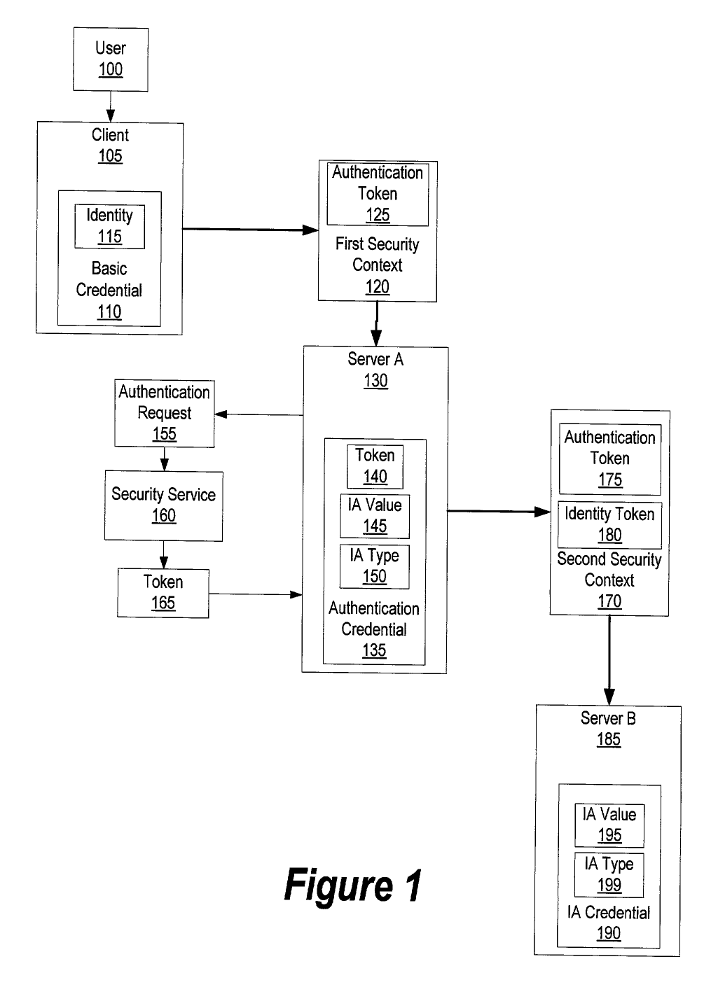

FIG. 1 is a diagram showing a server sending a security context message to a downstream server based upon a client request. User 100 sends a request to client 105. Client 105 retrieves identification information from user 100 and authenticates user 100. For example, user 100's identification information may be a user id and a password. When user 100 is authenticated, client 105 creates basic credential 110 and stores user 100's information in identity 115 which is located in basic credential 110. Using the example described above, user 100's user id and password are stored in identity 115.

Client 105 determines that user 100's request should be sent to server A 130. Client 105 creates first security context 120, retrieves user information from identity 115, and stores the user information in authentication token 125 which is located in first security context 120. Using the example described above, client 105 includes user 100's user id and password in authentication token 125. In one embodiment, authentication token 125 may include different mechanism-specific security information used by an authentication mechanism in common between a client and a server, such as a principal or distinguished name. Client 105 sends first security context 120 to server A 130 using a transport mechanism, such as SSL.

Server A 130 receives security context 120 and proceeds to authenticate user 100 using information in authentication token 125. Server A 130 retrieves identity information from authentication token 125. In one embodiment, server A 130 may retrieve user 100's identity information by extracting a certificate chain from the transport mechanism, such as SSL. If server A determines that user 100's identity information should be sent to security service 160 for authentication, server A 130 stores the identity information in authentication request 155 and sends authentication request 155 to security service 160. Security service 160 may be a server which is responsible for authenticating users. Security service 160 authenticates user 100 and sends token 165 to server A 130. Token 165 is an authentication token corresponding to user 100's identity in a format known by a specific mechanism, such as Kerberos, LTPA, or LocalOS.

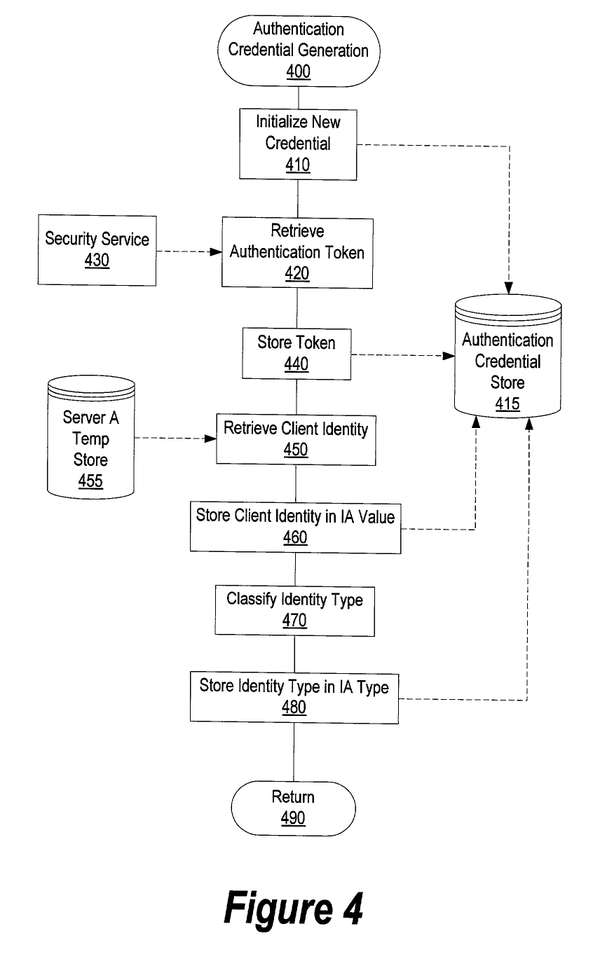

Server A 130 acknowledges authentication, and creates authentication credential 135. Server A 130 retrieves information from token 165 and stores the information in token 140. Server A 130 also retrieves identity assertion information from authentication token 125 or the transport mechanism and stores it in IA value 145 to be used in downstream requests. For example, server A 130 stores a principal, a distinguished name, or a certificate chain in IA value 145. Server A stores user 100's identity information in the same form as it was received. Server A 130 classifies which type of identity assertion is stored in IA value 140, and stores an identity assertion type identifier in IA type 150 (see FIG. 4 and corresponding text for further details regarding identity assertion types).

Server A 130 determines that user 100's request should be sent downstream to server B 185. Server A 130 creates second security context 170 and stores server A 130's identity information in authentication token 175. Server A 130 retrieves user 100's original identity information from IA value 145 and IA type 150 and stores both identity elements in identity token 180. Server A 130 then sends second security context 170 to server B 185 for processing.

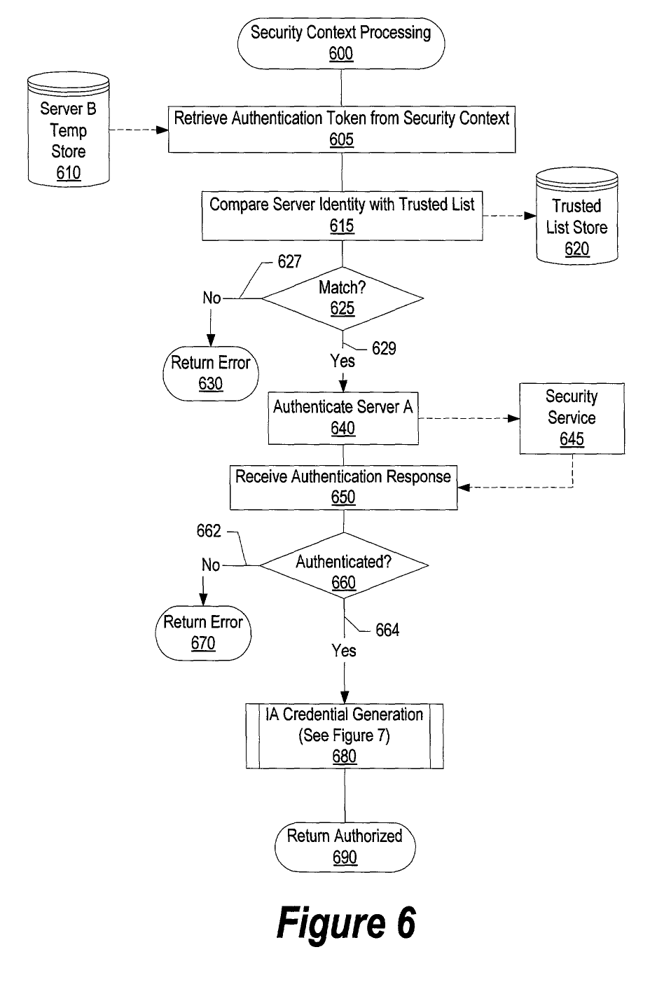

Server B 185 receives second security context 170. Server B 185 authenticates server A 130 by analyzing information in authentication token 175 (see FIG. 6 and corresponding text further details for information regarding server authentication). Once server A 130 is authenticated, server B 185 retrieves the identity assertion value and the identity assertion type identifier from identity token 180. Server B 185 creates IA credential 190 representing user 100. Server B 185 stores user 100's identity assertion value in IA value 195 and the IA type identifier in IA type 199.

If server B 185 recognizes that user 100's request should be sent to a downstream server, server B 185 uses information in IA value 195 and IA type 199 to create a security context to send to the downstream server. Or, if server B 185 determines that user 100 should be authorized, server B 185 uses IA value 195 and IA type 199 to perform authorization steps corresponding to user 100. The continued propagation of the original identity information preserves the integrity of the user's identity on a server-by-server basis. Each server may map this information to a credential in a way that it chooses based upon the server's underlying authentication mechanism and mapping rules.

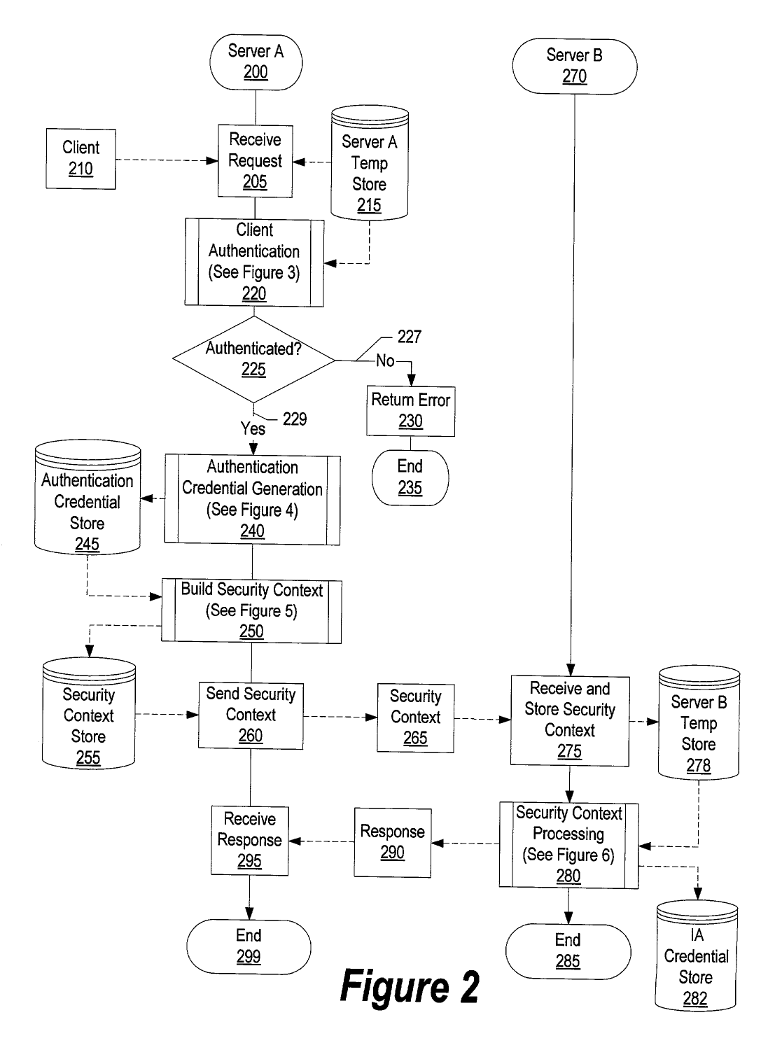

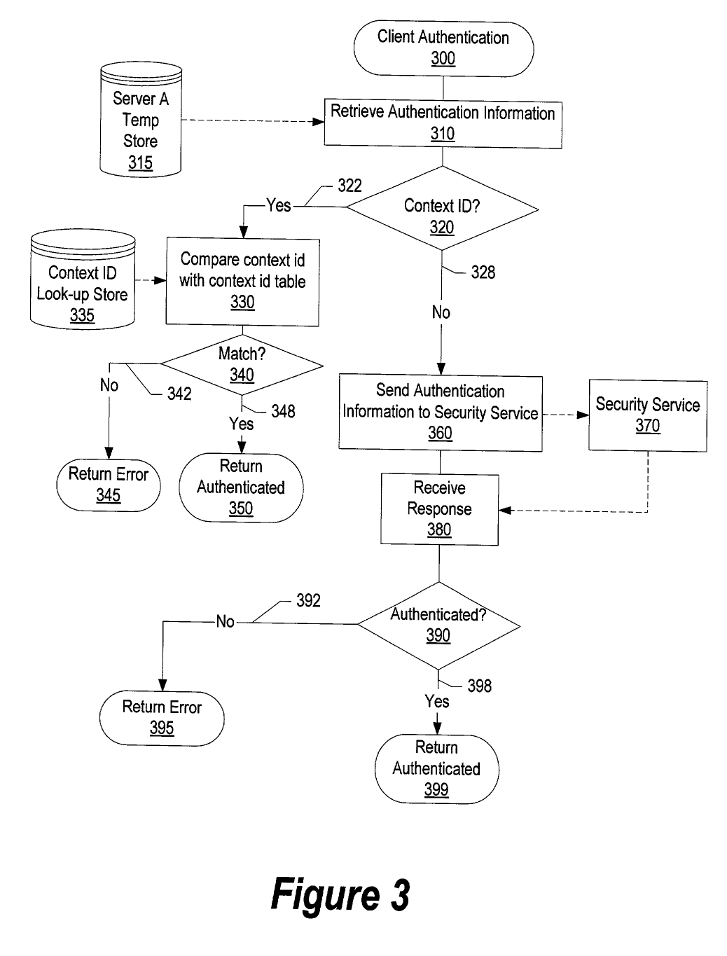

FIG. 2 is a high-level flowchart showing steps taken in an upstream server sending a security context to a downstream server. Server A processing commences at 200, whereupon server A receives a request from client 210 and stores the request in server A temp store 215 (step 205). The request may be a security context message which includes a user id/password combination, a digital certificate, or some other means of identification. Server A temp store 215 may be stored in a non-volatile storage area, such as a computer hard drive, or a volatile storage area, such as random access memory (RAM). Server A performs authentication steps to authenticate client 210 (pre-defined process block 220, see FIG. 3 and corresponding text for further details).

A determination is made as to whether client 210 was authenticated (decision 225). If client 210 was not authenticated, decision 225 branches to “No” branch 227 whereupon a return error is sent to client 210 (step 230) and processing ends at 235. On the other hand, if client 210 is authenticated, decision 225 branches to “Yes” branch 229. Processing generates an authentication credential corresponding to client 210 and stores the authentication credential in authentication store 245 (pre-defined process block 240, see FIG. 4 and corresponding text for further details). The authentication credential includes information such as an authentication token, an identity assertion value corresponding to client 210, and an identity assertion type identifier corresponding to the identity assertion value. Authentication credential store 245 may be stored in a non-volatile storage area, such as a computer hard drive, or a volatile storage area, such as random access memory (RAM).

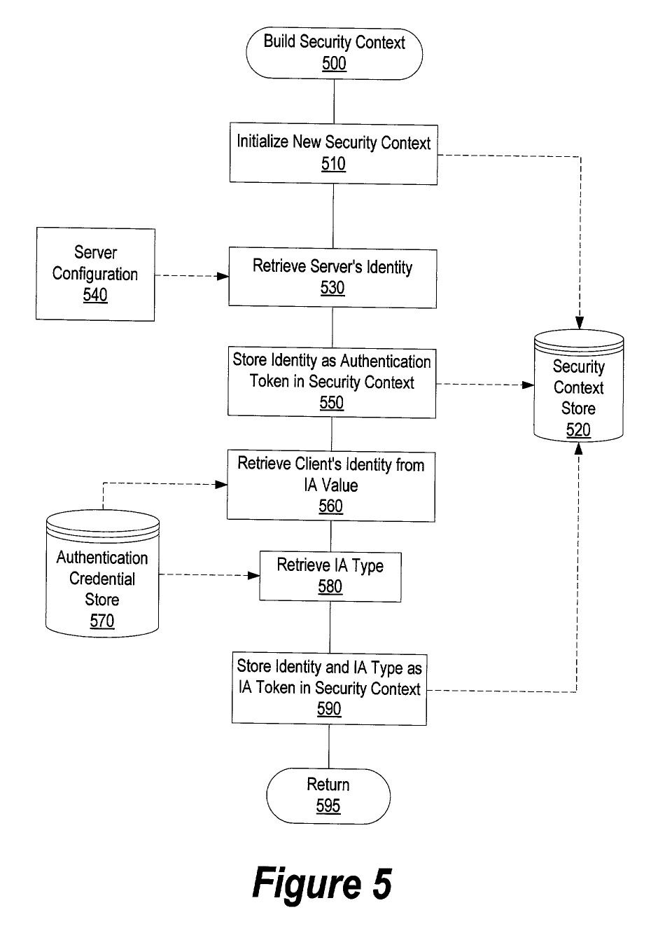

Processing generates a security context message using information in authentication credential store and stores the security context in security context store 255 (pre-defined process block 250, see FIG. 5 and corresponding text for further details). The security context includes information such as server A's identity information and an identity token which includes an IA value corresponding to client 210 and an IA type identifier corresponding to the IA value. The security context is typically stored in memory when a downstream request is about to be sent to a downstream server. Security context store 255 may be stored in a non-volatile storage area, such as a computer hard drive, or in a volatile storage area, such as random access memory (RAM).

Processing retrieves the security context from security context store 255 and sends security context 265 to downstream server B (step 260). Server B processing commences at 270, whereupon server B receives security context 265 and stores it in server B temp store 278 (step 275). Server B processes security context 265 to trust server A and generate an IA credential (pre-defined process block 280, see FIG. 6 and corresponding text for further details). Trusting server A entails checking that server A's identity is in a trusted list and authenticating or validating server A's authentication token. This is typically faster than authenticating the client's identity since the server's identity may be in a cache memory area.

Server B sends response 290 to server A. Response 290 may be an error message if server B is not able to trust server A, or response 290 may be an authentication approval message. Server A receives response 290 at step 295. Server A processing ends at 299.

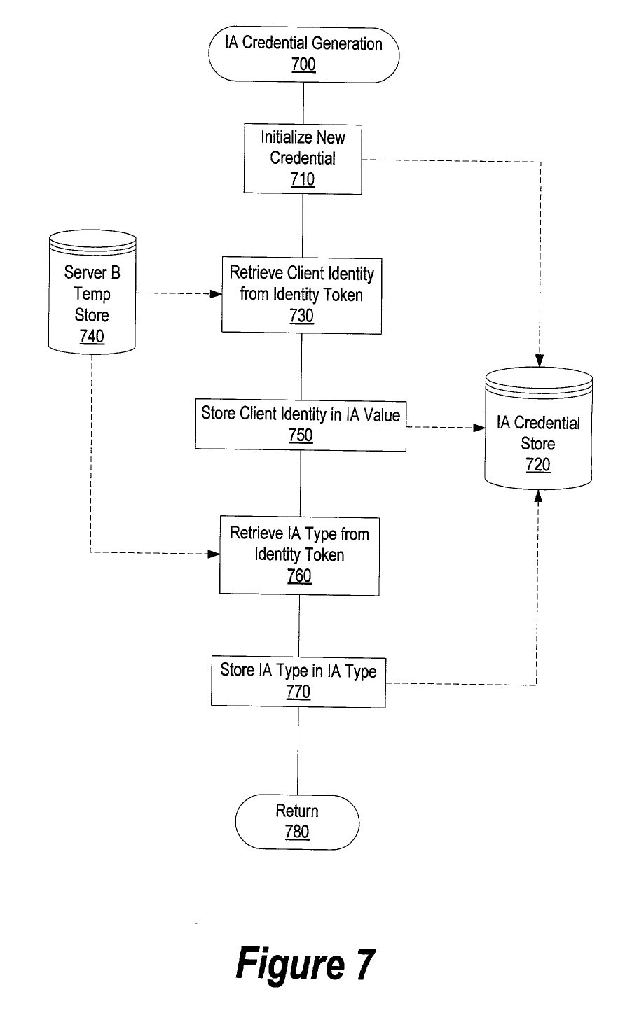

If server B trusts server A, server B generates an IA credential and stores the IA credential in IA credential store 282 (see FIG. 7 and corresponding text for further details regarding IA credential generation). IA credential store 282 may be stored in a non-volatile storage area, such as a computer hard drive, or may be stored in a volatile storage area, such as random access memory (RAM). Server B processing ends at 285.

FIG. 3 is a flowchart showing steps taken in authenticating a client. Client authentication processing commences at 300, whereupon processing retrieves authentication information corresponding to a client from server A temp store 315. Server A temp store 315 may be stored on a non-volatile storage area, such as a computer hard drive. For example, authentication information may include a user id and a password. A determination is made as to whether the authentication information is a context id indicating that the corresponding client has been previously authenticated (decision 320). If the authentication information includes a context id, decision 320 branches to “Yes” branch 322 whereupon processing compares the context id with a context id look-up table located in context id look-up store 335. Context id look-up store 335 may be stored in a non-volatile storage area, such as a computer hard drive.

A determination is made as to whether processing matched the client's context id with a context id in the context id table (decision 340). If processing did not match the client's context id, decision 340 branches to “No” branch 342 whereupon processing returns an error message at 345. On the other hand, if processing matched the client's context id, decision 340 branches to “Yes” branch 348 whereupon processing returns an authentication message at 350.

If the client's authentication information is not a context id, decision 320 branches to “No” branch 328 whereupon the authentication information is sent to security service 370 (step 360). Using the example described above, the user id and password are sent to security service 370. Security service 370 may be a server that is responsible for authenticating clients.

Processing receives a response from security service 370 at step 380. If security service authenticated the client, the response may be an authentication token. If the security service did not authenticate the client, the response may be a “Not Authenticated” message. A determination is made as to whether the client is authenticated (decision 390). If the client is not authenticated, decision 390 branches to “No” branch 392 whereupon an error message is returned at 395. On the other hand, if the client is authenticated, decision 390 branches to “Yes” branch 398 whereupon an authentication message is returned at 399.

FIG. 4 is a flowchart showing steps taken in generating an authentication credential using client information. Authentication credential generation processing commences at 400, whereupon a new authentication credential is initialized in authentication credential store 415 (step 410). Authentication credential store 410 may be stored in a non-volatile storage area, such as a computer hard drive, or in a volatile storage area, such as random access memory (RAM).

An authentication token is received from security service 430 at step 420. In one embodiment, the authentication token may be retrieved from a non-volatile storage area such as a computer hard drive. For example, if a client sent a context id as authentication, processing may look-up the context id and retrieve a corresponding authentication token from a non-volatile storage area.

Processing stores the authentication token in the new credential located in authentication credential store 415. Processing retrieves a client's identity from a client's request located in server A temp store 455. For example, the client's request may include a user id and password whereupon processing retrieves the user id. The client's identity is stored in an identity assertion (IA) value located in the new credential which is stored in authentication credential store 415 (step 460).

Processing analyzes the IA value and assigns an identity assertion (IA) type identifier corresponding to the IA value (step 470). For example, the IA type identifier may be based upon identity token formats included in a Common Object Request Broker Architecture (COBRA) specification in which the Object Management Group (OMG) supports. The identity assertion type identifier is stored in an IA type located in the new credential which is stored in authentication credential store 415 (step 480). Processing returns at 490.

FIG. 5 is a flowchart showing steps taken in building a security context using an authentication credential and a server's identity. A security context is an in-memory object for each request from a client to a server or from a first server to a second server. Security context building processing commences at 500, whereupon a new security context is initialized in security context store 520. Security context store 520 may be stored in a non-volatile storage area, such as a computer hard drive. The server's identity is retrieved from server configuration 540 (step 530). Server configuration 540 may be located on the server and the server's identity may be an authentication token in which a downstream server recognizes. The server's identity is stored in an authentication token located in the new security context which is stored in security context store 520 (step 550).

A client's identity is retrieved from an identity assertion (IA) value located in a corresponding authentication credential which is stored in authentication credential store 570. For example, the client's identity may be a principal, distinguished name, or certificate chain. Authentication credential store 570 may be stored in a non-volatile storage area, such as a computer hard drive. An identity assertion (IA) type identifier corresponding to the IA value is retrieved from an IA Type located in the corresponding authentication credential which is stored in authentication credential store 570. The IA type identifier corresponds to the type of identity assertion of the IA value (see FIG. 4 and corresponding text for further details regarding IA values and IA types).

The IA value and IA type are combined to generate an IA token which is stored in the new security context located in security context store 520. Processing returns at 595.

FIG. 6 is a flowchart showing steps taken in a downstream server processing a security context message which is sent from an upstream server. Server B security context processing commences at 600, whereupon an authentication token is retrieved from a security context message located in server B temp store 610. The security context message was previously sent from an upstream server A and the authentication token includes server A's identity. Server B temp store 610 may be stored on a non-volatile storage area, such as a computer hard drive. Processing compares server A's identity with a trusted list located in trusted list store 620. The trusted list includes a list of servers which are trusted by the corresponding server (i.e. server B). Trusted list store 620 may be stored in a non-volatile storage area, such as a computer hard drive.

A determination is made as to whether processing matched server A's identity with an entry in the trusted list (decision 625). If processing did not match server A's identity with an entry in the trusted list, decision 625 branches to “No” branch 627 whereupon an error message is returned at 630. On the other hand, if processing did match server A's identity with an entry in the trusted list, decision 625 branches to “Yes” branch 629.

Processing sends server A's authentication information to security service 645 for a simple authentication. Security service 645 performs a simple authentication by checking the user id and password for validity. Security service 645 may not return a token or credential during a simple authentication. Processing receives a response form security service 645 at step 650. A determination is made as to whether server A was authenticated (decision 660). If server A was not authenticated, decision 660 branches to “No” branch 662 whereupon an error message is returned at 670. On the other hand, if server A was authenticated, decision 660 branches to “Yes” branch 664 whereupon processing creates an identity assertion (IA) credential (pre-defined process block 680, see FIG. 7 and corresponding text for further details). Processing returns an authorization message at 690.

FIG. 7 is a flowchart showing steps taken in creating an identity assertion (IA) credential. IA credential generation processing commences at 700, whereupon a new IA credential is initialized in IA credential store 720 (step 710). IA credential store 720 may be stored in a non-volatile storage area, such as a computer hard drive.

Processing retrieves a client's identity from an identity token located in server B temp store 740 (step 730). For example, the client's identity may include a user id. Server B temp store 740 may be stored in non-volatile storage area, such as a computer hard drive. The client's identity is stored in an identity assertion (IA) value located in the new credential which is stored in IA credential store 720 (step 750).

Processing retrieves an IA type identifier from the identity token at step 760. The IA type identifier corresponds to the format of the client's identity. For example, the IA type identifier may be based upon identity token formats included in a Common Object Request Broker Architecture (COBRA) specification in which the Object Management Group (OMG) supports. The identity assertion type identifier is stored in an IA type located in the new credential which is stored in IA credential store 720 (step 770). Processing returns at 780.

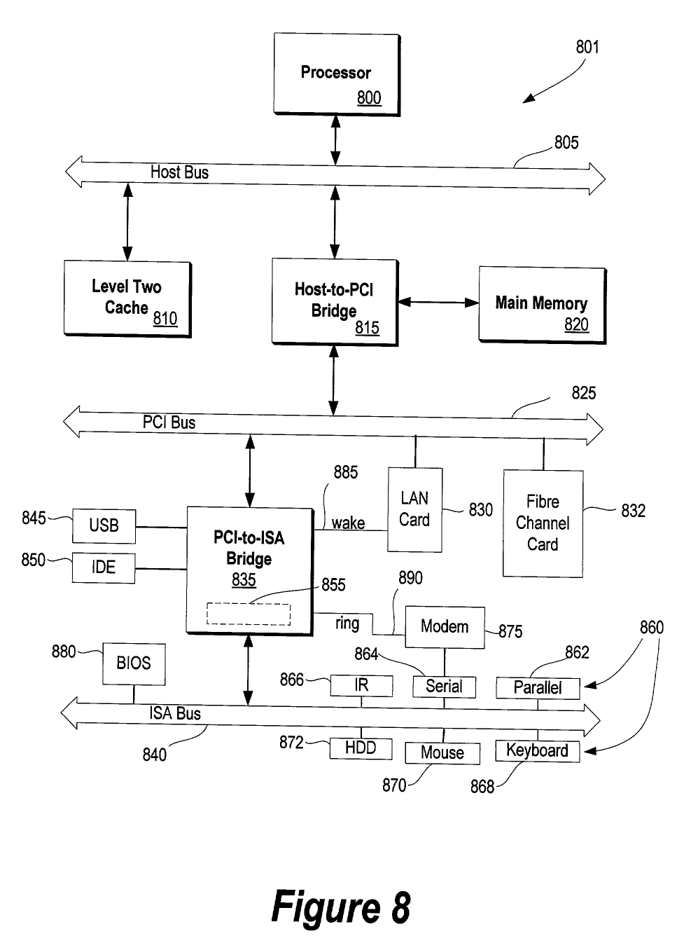

FIG. 8 illustrates information handling system 801 which is a simplified example of a computer system capable of performing the server and client operations described herein. Computer system 801 includes processor 800 which is coupled to host bus 805. A level two (L2) cache memory 810 is also coupled to the host bus 805. Host-to-PCI bridge 815 is coupled to main memory 820, includes cache memory and main memory control functions, and provides bus control to handle transfers among PCI bus 825, processor 800, L2 cache 810, main memory 820, and host bus 805. PCI bus 825 provides an interface for a variety of devices including, for example, LAN card 830. PCI-to-ISA bridge 835 provides bus control to handle transfers between PCI bus 825 and ISA bus 840, universal serial bus (USB) functionality 845, IDE device functionality 850, power management functionality 855, and can include other functional elements not shown, such as a real-time clock (RTC), DMA control, interrupt support, and system management bus support. Peripheral devices and input/output (I/O) devices can be attached to various interfaces 860 (e.g., parallel interface 862, serial interface 864, infrared (IR) interface 866, keyboard interface 868, mouse interface 870, and fixed disk (HDD) 872) coupled to ISA bus 840. Alternatively, many I/O devices can be accommodated by a super I/O controller (not shown) attached to ISA bus 840.

BIOS 880 is coupled to ISA bus 840, and incorporates the necessary processor executable code for a variety of low-level system functions and system boot functions. BIOS 880 can be stored in any computer readable medium, including magnetic storage media, optical storage media, flash memory, random access memory, read only memory, and communications media conveying signals encoding the instructions (e.g., signals from a network). In order to attach computer system 801 to another computer system to copy files over a network, LAN card 830 is coupled to PCI bus 825 and to PCI-to-ISA bridge 835. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for handling network security, said method comprising:
receiving, at a first server, a first request from a requestor;
authenticating the request;
extracting an identity assertion value corresponding to the requestor in response to the authentication;
identifying an identity assertion type corresponding to the identity assertion value; and
storing the identity assertion value and the identity assertion type in an authentication credential.

2. The method as described in claim 1 further comprising:
creating a second request;
inserting the identity assertion value and the identity assertion type in the second request; and
sending the second request to a downstream server.

3. The method as described in claim 2 wherein the second request includes an authentication token corresponding to the first server's identity and wherein the downstream server includes an authentication means that is adapted to authenticate the first server using the authentication token.

4. The method as described in claim 3 further comprising:
receiving the second request;
authenticating the first server using the authentication token wherein the authentication includes a simple authentication; and
trusting the first server based upon the authentication.

5. The method as described in claim 4 further comprising:
creating an identity assertion credential at the downstream server in response to the trusting;
storing the identity assertion value and the identity assertion type in the identity assertion credential; and
authorizing the user based upon the identity assertion value and the identity assertion type.

6. The method as described in claim 1 further comprising:
authorizing the request using a first security mechanism;
creating a security credential that includes an identity token, the identity token including the identity assertion value and the identity assertion type; and
sending the security credential to a downstream server, wherein the downstream server is adapted to authorize the token using a second security mechanism.

7. The method as described in claim 6 wherein the first and second security mechanisms are selected from the group consisting of LTPA, Kerberos, and LocalOS.

8. An information handling system comprising:
one or more processors;
a memory accessible by the processors;
one or more nonvolatile storage devices accessible by the processors;
a network security tool to handle network security, the network security tool including:
means for receiving, at a first server, a first request from a requestor;
means for authenticating the request;
means for extracting an identity assertion value corresponding to the requester in response to the authentication;
means for identifying an identity assertion type corresponding to the identity assertion value; and
means for storing the identity assertion value and the identity assertion type in an authentication credential.

9. The information handling system as described in claim 8 further comprising:
means for creating a second request;
means for inserting the identity assertion value and the identity assertion type in the second request; and
means for sending the second request to a downstream server.

10. The information handling system as described in claim 9 wherein the second request includes an authentication token corresponding to the first server's identity and wherein the downstream server includes an authentication means that is adapted to authenticate the first server using the authentication token.

11. The information handling system as described in claim 10 further comprising:
means for receiving the second request;
means for authenticating the first server using the authentication token wherein the authentication includes a simple authentication; and
means for trusting the first server based upon the authentication.

12. The information handling system as described in claim 11 further comprising:
means for creating an identity assertion credential at the downstream server in response to the trusting;
means for storing the identity assertion value and the identity assertion type in the identity assertion credential; and
means for authorizing the user based upon the identity assertion value and the identity assertion type.

13. The information handling system as described in claim 8 further comprising:
means for authorizing the request using a first security mechanism;
means for creating a security credential that includes an identity token, the identity token including the identity assertion value and the identity assertion type; and
means for sending the security credential to a downstream server, wherein the downstream server is adapted to authorize the token using a second security mechanism.

14. A computer program product stored in a computer operable media for handling network security, said computer program product comprising:
means for receiving, at a first server, a first request from a requestor;
means for authenticating the request;
means for extracting an identity assertion value corresponding to the requester in response to the authentication;
means for identifying an identity assertion type corresponding to the identity assertion value; and
means for storing the identity assertion value and the identity assertion type in an authentication credential.

15. The computer program product as described in claim 14 further comprising:
means for creating a second request;
means for inserting the identity assertion value and the identity assertion type in the second request; and
means for sending the second request to a downstream server.

16. The computer program product as described in claim 15 wherein the second request includes an authentication token corresponding to the first server's identity and wherein the downstream server includes an authentication means that is adapted to authenticate the first server using the authentication token.

17. The computer program product as described in claim 16 further comprising:
means for receiving the second request;
means for authenticating the first server using the authentication token wherein the authentication includes a simple authentication; and
means for trusting the first server based upon the authentication.

18. The computer program product as described in claim 17 further comprising:
means for creating an identity assertion credential at the downstream server in response to the trusting;
means for storing the identity assertion value and the identity assertion type in the identity assertion credential; and
means for authorizing the user based upon the identity assertion value and the identity assertion type.

19. The computer program product as described in claim 14 further comprising:
means for authorizing the request using a first security mechanism;
means for creating a security credential that includes an identity token, the identity token including the identity assertion value and the identity assertion type; and
means for sending the security credential to a downstream server, wherein the downstream server is adapted to authorize the token using a second security mechanism.

20. The computer program product as described in claim 6 wherein the first and second security mechanisms are selected from the group consisting of LTPA, Kerberos, and LocalOS.
